(19) United States
(12) Patent Application Publication
(10) Pub. No.: US 2021/0241267 A1
(43) Pub. Date: Aug. 5, 2021

(54) ELECTRONIC METHODS AND SYSTEMS FOR PROCESSING A DECLINED FINANCIAL TRANSACTION

(71) Applicant: MASTERCARD INTERNATIONAL INCORPORATED, Purchase, NY (US)

(72) Inventors: Kalpesh Pandharinath MAHAJAN, Pune (IN); Krutika Eknath GONNADE, Pune (IN); Abhishek CHATURVEDI, Lucknow (IN)

(21) Appl. No.: 17/166,710

(22) Filed: Feb. 3, 2021

(30) Foreign Application Priority Data
Feb. 4, 2020 (IN) 202041004805

(51) Int. Cl. G06Q 20/38; G06Q 20/40

(52) U.S. Cl. CPC G06Q 20/3821; G06Q 20/3823; G06Q 20/40145

(57) ABSTRACT

Embodiments provide methods, and server systems for processing a declined transaction. A method includes receiving, by a server system associated with a payment network, a declined transaction notification signal about an identification of an authentication credential of a payment card provided by a user for initiating a transaction in a transaction capturing device as incorrect. The method includes verifying if the user has opted for a dual authentication service facilitating re-authentication of the declined transaction via an application. If yes, the method includes sending a user approval notification signal to a user device via the application. The method includes receiving, the user approval of providing the incorrect authentication credential. The method includes electronically facilitating re-authentication of the transaction via the application by requesting the user to provide a re-authentication credential. The method includes electronically facilitating a completion of the declined transaction based on verification of the re-authentication credential.

### TECHNICAL FIELD

The present disclosure relates to electronic payment transactions and, more particularly to, methods and systems for electronically processing a payment transaction declined due to an incorrect authentication credential.

### BACKGROUND

Nowadays, many consumers use several banking cards, such as credit cards, debit cards, prepaid cards, etc., for performing electronic transactions. The various banking cards are herein referred to as payment cards. Authentication refers to the identity check of the consumer proving to an issuer bank that it is indeed him/her performing a transaction. A unique Personal Identification Number (PIN), therefore, is associated with each payment card of the consumer for authentication purposes. For a financial transaction, such as a cash withdrawal using a debit card at an Automated Teller Machine (ATM), the consumer needs to enter the associated PIN at the ATM to authenticate himself and only after the PIN is verified, the cash is released to the consumer. Online purchases) done using credit or debit cards are also required to be authenticated using the respective PINs/passwords. Additionally, a payment card that is used at a POS terminal present in a merchant facility for purchasing goods or services from a merchant may also require user authentication using the PIN associated with the used payment card.

The use of the payment cards for various financial transactions (e.g., a payment transaction) and non-financial transactions (e.g., balance inquiry) has increased remarkably over the recent years. The consumer needs to remember the unique PIN associated with each of the payment cards possessed by him to perform different types of transactions in his day-to-day life. Many a times, it happens that the consumer forgets the PIN and enters an incorrect PIN or accidently enters a wrong PIN, for example, at the ATM for cash withdrawal using a debit card. In normal scenario, the consumer is given a predefined number (e.g., three) of attempts to enter a correct PIN and if all of the attempts fail, the transaction is declined by the ATM and moreover, the debit card also gets blocked. Each failed attempt of the PIN entry ends up in an inconvenience for the consumer and the participating entities involved in the payment chain such as an acquirer bank, an issuer bank and a payment network. Such unsuccessful attempts of PIN entry, in turn, involve unnecessary traffic on the network for non-financial transactions and also involve revenue loss to the issuer. For instance, the issuer is required to pay a pre-determined fee to the acquirer for a declined transaction and even for incorrect PIN.

Accordingly, there exists a need to device alternate mechanisms of PIN entry after each unsuccessful PIN entries by authorized consumers and to reduce unnecessary traffic faced by the components involved in the electronic payment transaction process.

### BRIEF SUMMARY

Various embodiments of the present disclosure provide systems, methods, electronic devices and computer program products for processing a declined transaction due to an incorrect authentication credential by re-authenticating the declined transaction via an application.

In an embodiment, a computer-implemented method is disclosed. The method includes receiving, by a server system associated with a payment network, a declined transaction notification signal about an identification of an authentication credential of a payment card associated with a user as incorrect. The authentication credential is provided by the user for initiating a transaction in a transaction capturing device. The method includes, verifying, by the server system, if the user has opted for a dual authentication service. The dual authentication service includes facilitating re-authentication of the declined transaction via an application. If the user has opted for the dual authentication service, the method includes sending, by the server system, a user approval notification signal to a user device via the application. The user approval notification signal seeks a user approval of providing the incorrect authentication credential. The method includes receiving, via the application, by the server system, the user approval of providing the incorrect authentication credential. The method includes electronically facilitating, by the server system, re-authentication of the transaction via the application. Re-authentication includes requesting the user to provide a re-authentication credential via the application. The method includes electronically facilitating, by the server system, a completion of the declined transaction based on verification of the re-authentication credential.

In another embodiment, a server system in a payment network is provided. The server system includes a communication interface configured to receive a declined transaction notification signal about an identification of an authentication credential of a payment card associated with a user as incorrect. The authentication credential is provided by the user for initiating a transaction in a transaction capturing device. The server system includes a memory including executable instructions and a processor communicably coupled to the communication interface. The processor is configured to execute the instructions to cause the server system to at least verify if the user has opted for a dual authentication service. The dual authentication service includes facilitating re-authentication of the declined transaction via an application. If the user has opted for the dual authentication service, the server system is further caused to send a user approval notification signal to a user device via the application. The user approval notification signal seeks a user approval of providing the incorrect authentication credential. The server system is further caused to receive, via the application, the user approval of providing the incorrect authentication credential. The server system is further caused to electronically facilitate re-authentication of the transaction via the application. Re-authentication includes requesting the user to provide a re-authentication credential via the application. The server system is further caused to electronically facilitate a completion of the declined transaction based on verification of the re-authentication credential.

In yet another embodiment, another computer-implemented method is disclosed. The method includes identifying, by a server system associated with a payment network, an authentication credential of a payment card associated with a user as incorrect. The authentication credential is provided by the user for initiating a transaction in a transaction capturing device. The method includes declining, by the server system, the transaction based on identification of the incorrect authentication credential provided by the user. The method includes sending, by the server system, a user approval notification signal to a user device via an application. The user approval notification signal seeks a user approval of providing the incorrect authentication credential. The method includes receiving, via the application, by the server system, the user approval of providing the incorrect authentication credential. The method includes electronically facilitating, by the server system, re-authentication of the transaction via the application. Re-authentication includes requesting the user to provide a re-authentication credential via the application. The method includes electronically facilitating, by the server system, a completion of the declined transaction based on verification of the re-authentication credential.

### BRIEF DESCRIPTION OF THE DRAWINGS

For a more complete understanding of example embodiments of the present technology, reference is now made to the following descriptions taken in connection with the accompanying drawings in which:

FIG. 1 illustrates an example representation of an environment, related to at least some example embodiments of the present disclosure;

FIGS. 2A-2B are a sequence flow diagram representing re-authentication of a declined transaction using an application, in accordance with an example embodiment;

FIGS. 3A-3B are a sequence flow diagram representing re-authentication of a declined transaction using an application, in accordance with another example embodiment;

FIGS. 4A-4B are a sequence flow diagram representing processing of a declined non-financial transaction using an application, in accordance with an example embodiment;

FIGS. 5A-5B are a sequence flow diagram representing processing of a declined transaction using an application, in accordance with another example embodiment;

FIG. 6 is a sequence flow diagram representing reporting a declined transaction as a fraud transaction using an application, in accordance with an example embodiment;

FIG. 7A represents a User Interface (UI) for seeking a user approval of providing an incorrect authentication credential via an application, in accordance with an example embodiment;

FIG. 7B represents a UI for displaying modes of re-authentication facilitated via the application for user selection, in accordance with an example embodiment;

FIG. 8A represents a UI for seeking a user approval of providing a correct authentication credential via an application, in accordance with an example embodiment;

FIG. 8B represents a UI for displaying modes of re-authentication facilitated via the application for user selection, in accordance with an example embodiment;

FIG. 9A and FIG. 9B collectively represent UIs for electronically facilitating an extension of time for performing re-authentication process, in accordance with an example embodiment;

FIG. 10 is a flow diagram of a method for processing a declined transaction, in accordance with an example embodiment;

FIG. 11 is a flow diagram of another method for processing a declined transaction, in accordance with an example embodiment;

FIG. 12 is a simplified block diagram of a server system, in accordance with one embodiment of the present disclosure;

FIG. 13 is a simplified block diagram of an issuer server, in accordance with one embodiment of the present disclosure;

FIG. 14 is a simplified block diagram of an acquirer server, in accordance with one embodiment of the present disclosure;

FIG. 15 is a simplified block diagram of a payment server, in accordance with one embodiment of the present disclosure; and

FIG. 16 is a simplified block diagram of a user device capable of implementing at least some embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” at various places in the specification is not necessarily all referring to the same embodiment, nor to separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refers to a financial account that is used to fund the financial transaction (interchangeably referred to as “payment transaction”). Examples of the payment account include, but are not limited to a savings account, a credit account, a checking account and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by digital wallet or other payment application.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be operated to perform transactions via cash-substitutes, which may include payment cards, letters of credit, checks, financial accounts, etc. One example of a payment network includes those operated by Mastercard.

The term “payment card”, used throughout the description, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively, or additionally, the payment card may be embodied in form of data (e.g., a digital token) stored in a user device, where the data is associated with the payment account such that the data can be used to process the financial transaction between the payment account and a merchant's financial account.

The term “transaction” used throughout the description, unless context suggests otherwise, includes electronic financial transactions such as cash withdrawal, online payment, payment at POS terminal, and the like, and also includes financial related transactions such as balance enquiry, account statement generation, addition of a beneficiary or activation/deactivation of finance related services, etc.

### Overview

Various example embodiments of the present disclosure provide methods, systems, user devices and computer program products for further processing a declined financial transaction due to a wrong authentication credential provided by a consumer/user during a transaction by way of enabling the user to re-authenticate the declined transaction using an application.

In various example embodiments, the present disclosure provides a server system e.g., a payment server in a payment network configured to receive an authentication credential (e.g., a PIN) of a payment card associated with a user from an acquirer server. The authentication credential is provided by the user for initiating a financial transaction for a transaction amount in a transaction capturing device such as a Point of Sale (POS) terminal or an ATM or via an e-commerce application running on a user device. Alternatively, the authentication credential is provided by the user for initiating a non-financial transaction in a transaction capturing device such as the ATM to perform various functions such as change of user details, balance inquiry, mini statement printing, PIN change, cheque book request and the like.

The transaction capturing device sends the authentication credential to the acquirer server for initiating the authentication of the user for processing the transaction. The transaction capturing device also sends the payment card details and the transaction amount (if the transaction is a financial transaction) for authorization. The payment server sends the authentication credential for verification to an issuer server. The issuer server is also configured to perform authorization of the payment card details and the transaction amount. If the authentication credential provided by the user is incorrect, the issuer server is configured to generate a declined transaction notification signal upon unsuccessful verification of the authentication credential. The incorrect authentication credential would be a mismatch with the stored authentication credential that is associated with the payment card at the time of registration. The payment server is notified by the issuer server by sending the declined transaction notification signal about identification of the incorrect authentication credential.

In one embodiment, the payment server is configured to facilitate a dual authentication service to the user and the issuer. The payment server facilitates re-authentication of the declined transaction via an application (e.g., a payment application) if the user and his card issuer both have opted for the dual authentication service. One important feature of the service is to electronically facilitate an extension of a pre-determined time period to the user to perform the re-authentication. The dual authentication service is performed for both type of transactions where the authentication credential is correctly performed and where the authentication credential is incorrectly provided.

Upon receiving the declined transaction notification signal, the payment server verifies if the user has opted for the dual authentication service. If yes, the payment server sends a user approval notification signal seeking a user approval of providing the incorrect authentication credential to a user device using a User Interface (UI) of the application. The user is also given an option to deny/decline providing the incorrect authentication credential using the UI. If the user sends a user denial of providing the incorrect authentication credential via the application, the transaction is electronically reported as a fraud transaction and the transaction is aborted by the payment server.

However, if the user sends a user approval of providing the incorrect authentication credential via the application, the payment server is configured to electronically facilitate re-authentication of the transaction by requesting the user to provide a re-authentication credential via the application. A re-authentication credential may be same as the authentication credential as originally provided by the user at the transaction capturing device or it may be different from the originally provided authentication credential. The payment server is configured to verify the re-authentication credential received via the application from the user device. In one embodiment, the re-authentication credential may be sent to the issuer server for verification by the payment server. Upon successful verification, the payment server is configured to notify the acquirer server and the transaction is processed further for completion.

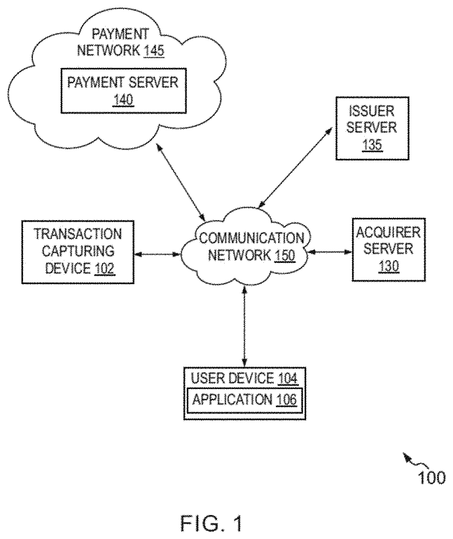

In one embodiment, the application to facilitate re-authentication of a declined transaction is provided by the issuer server. In that scenario, after declining the transaction based on identification of the incorrect authentication credential provided by the user, the issuer server sends the declined transaction notification signal to the payment server. The payment server verifies if the user has opted for the dual authentication service. If the user has opted for the dual authentication service, the payment server is configured to send a successful verification notification signal to the issuer sever. Thereafter, the issuer server sends the user approval notification signal to the user device via the application to seek user approval of providing the incorrect authentication credential. Upon receiving user approval, the issuer server facilitates re-authentication of the declined transaction by requesting the user to provide a re-authentication credential via the application. The issuer server verifies the re-authentication credential, notifies the payment server and the acquirer server of successful verification of the re-authentication credential and the transaction is processed further for completion. Various example embodiments of present disclosure are described hereinafter with reference to FIGS. 1 to 16.

FIG. 1 illustrates an example representation of an environment 100, in which at least some example embodiments of the present disclosure can be implemented. A transaction capturing device 102 (hereinafter alternatively referred to as a transaction device 102) is shown in communication with various entities of a payment network 145 and a user device 104 via a communication network 150. Some non-exhaustive examples of the transaction device 102 include an ATM, a POS terminal, a Tap and Pay contactless transaction device, a personal computer (PC), a mobile phone, a tablet device, a Personal Digital Assistant (PDA), a voice activated assistant, a Virtual Reality (VR) device, a smartphone and a laptop. Some non-exhaustive examples of the user device 104 include, but are not limited to, a desktop computer, a personal computer (PC), a mobile phone, a tablet device, a Personal Digital Assistant (PDA), a voice activated assistant, a Virtual Reality (VR) device, a smartphone and a laptop.

In one example embodiment, a user (not shown) provides an authentication credential of a payment card at the transaction device 102 to initiate a financial transaction for a transaction amount. For example, the user may be at a merchant facility that has a POS terminal to accept the payment card of the user for processing a payment transaction for the purchase of the goods from the merchant. The user is provided a payment card by a card issuer such as an issuer bank. A corresponding issuer server 135 is associated with a financial institution normally called as an “issuer bank” or “issuing bank” or simply “issuer”, in which the user may have an account, which issues a payment card, such as a credit card or a debit card. The user can use the payment card data associated with the payment card to tender payment for a purchase from a merchant, use it at an ATM to withdraw cash or perform other non-financial activities.

To initiate processing of the payment transaction, the POS terminal requests the user to enter the associated PIN (an example of the authentication credential) of the payment card. The user enters the PIN. To accept payment, the merchant will first establish an account with a financial institution that is part of the financial payment system. This financial institution is usually called the “merchant bank” or the “acquiring bank” or “acquirer bank” or simply “acquirer”. The acquirer server 130 is associated with the acquirer bank. The POS terminal is configured to send the PIN and the transaction amount data to the acquirer server 130 for authentication and authorization, respectively.

The acquirer server 130 sends the PIN and the transaction amount data to the issuer server 135 via a payment server 140 associated with the payment network 145. The payment network 145 may be used by the payment cards issuing authorities as a payment interchange network. Additionally, various data such as a payment card data of the payment card of the user, at least one transaction identifier data and the like may also be sent. The issuer server 135 is configured to match the received PIN with a PIN stored in a database to verify the PIN. In at least one embodiment, the PIN entered by the user at the POS terminal is an incorrect PIN. The issuer server 135, therefore, declines the payment transaction for an unsuccessful verification of the PIN.

Considering another example scenario, the user may be checking out a number of items to be purchased in a merchant application (i.e., an e-commerce application) that is running in the user device 104 (an example of the transaction device 102). The merchant application can be a merchant website, mobile or desktop applications, or third-party websites or applications using which the consumer/user may purchase goods or services from a remote location. The user may be asked to enter the payment card details of the payment card in a UI of the merchant application. The payment card details include a name of the cardholder, a payment card number (e.g., xxxx xxxx xxxx xxxx where ‘x’ is an integral number) of the payment card, an expiry date (e.g., MM/YYYY, month and year of expiry), a CVV number (e.g., *** where * is an integral number) and the like. Alternatively, the payment card details may include information such as cardholder's payment account number, or any identification number associated with the payment card.

Thereafter, the user may be directed to a UI to enter a long-term pre-set password or a One-Time Password (OTP) sent by the participating bank on the user's registered mobile number. For instance, the user enters the password to initiate the authentication process. As explained above, eventually, the issuer server 135 receives the password for verification through the chain of payment entities. In at least one embodiment, the password entered by the user using the user device 104 for processing the e-commerce transaction is incorrect. The issuer server 135, therefore, declines the e-commerce transaction for an unsuccessful verification of the password.

Various embodiments of the present disclosure provide mechanisms such that the user is enabled to re-authenticate a declined transaction using an application 106 facilitated by the payment server 140. The application 106 may be a payment application that provides digitization of the payment cards to process electronic transactions with additional feature of dual authentication service. The application 106 may be a mobile application or a web application. In one embodiment, the payment server 140 provides a dual authentication service to the user which upon being opted, allows the user to re-authenticate a declined transaction using the application 106 running on a user device 104. The issuer also needs to enroll for the service so as to be able to convert a declined transaction to a successfully performed transaction and eventually receive the applicable fees for the same. The dual authentication service also electronically facilitates extension of session time to the user to complete the re-authentication process.

In an alternate embodiment, the application 106 may be facilitated by the issuer server 135. The approval notification about a declined transaction can be sent by the issuer server 135 or the payment server 140 via the corresponding applications facilitated by each entity. The user is requested to approve the wrong PIN/password entry and provide a re-authentication credential that may be the same PIN/password as correctly recalled by the user or any other type of re-authentication credential using corresponding User Interfaces (UIs) of the application 106 running in the user device 104. Once the re-authentication credential is successfully verified, the payment transaction is processed further.

Using the payment network 145, the computers of the acquirer bank/the acquirer server 130 or the merchant processor will communicate with the computers of the issuer/the issuer server 135 to determine whether the user's account is in good standing and whether the purchase is covered by the user's available account balance. Based on these determinations, authorization of the payment transaction is declined or accepted. When the authorization is accepted, the available balance of the customer's account is decreased. According to a process of one payment network operator, a charge is not posted immediately to the customer's account as a merchant will not charge, or “capture,” a transaction amount until goods are shipped or services are delivered. When the merchant ships or delivers the goods or services, the merchant captures the transaction amount by, for example, appropriate data entry procedures in the merchant application. If the customer cancels a transaction before it is captured, a “void” is generated. If the customer returns goods after the transaction has been captured, a “credit” is generated.

After a transaction is captured, the transaction is settled among the merchant, the acquirer and the issuer. Settlement refers to the transfer of financial data or funds among the merchant's account, the acquirer, and the issuer, related to the transaction. Transactions may be captured and accumulated into a “batch”, which is settled as a group.

In a non-limiting example, the process of re-authentication of the declined transaction and completion of transaction after successful verification of the re-authentication is processed by a combination of the acquirer server 130, the issuer server 135, and the payment server 140. The transaction device 102, the user device 104, the issuer server 135, the acquirer server 130, and the payment server 140 communicate with one another using the communication network 150. Examples of the communication network 150 may include any type of wired network, wireless network, or a combination of wired and wireless networks. A wireless network may be a wireless local area network (“WLAN”), a wireless wide area network (“WWAN”), or any other type of wireless network now known or later developed. Additionally, the communication network 150 may be or include the Internet, intranets, extranets, microwave networks, satellite communications, cellular systems, personal communication services (“PCS”), infrared communications, global area networks, or other suitable networks, etc., or any combination of two or more such networks.

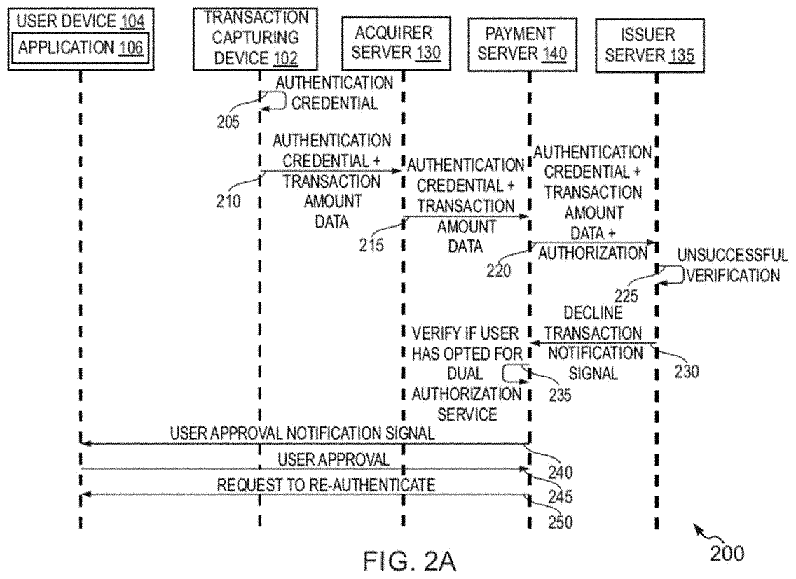

In existing (conventional) transaction methods (i.e., not in accordance with the present disclosure), a declined transaction due to incorrect authentication credential ends up in fees loss to the participating entities and the user experience also gets affected. Further, a declined transaction causes unnecessary traffic on the network. In contrast to existing transaction methods, by using the embodiments of the present disclosure, the user is enabled to re-authenticate a declined transaction by registering for a dual authentication service and also, report the declined transaction as fraud if the incorrect authentication credential is not provided by the user himself. This helps in minimizing the transaction frauds and decreasing a number of declined transactions. Further, revenue loss that would occur for a declined non-financial transaction comes down tremendously and user satisfaction is achieved simultaneously. Some non-exhaustive example embodiments of re-authenticating and completing a declined transaction due to incorrect authentication credential using a dedicated application are described with reference to the following description, particularly with reference to FIGS. 2A-2B to 9A-9B.

FIG. 2A, 2B collectively represent a sequence flow diagram 200 representing re-authentication of a declined transaction using an application, in accordance with an example embodiment. More specifically, the sequence flow diagram 200 represents re-authentication of a declined financial transaction using the application 106 facilitated by the payment server 140 of FIG. 1.

At 205, a user enters/provides an authentication credential of a payment card to the transaction capturing device 102 for processing a transaction for a transaction amount. The transaction capturing device 102 may be capable of capturing authentication credential for the payment card of the user for processing financial and non-financial transactions. For example, the user wants to purchase an electronic item worth 5000 INR from an electronic store using a debit card via a tap and pay contactless transaction device. Once the user taps the debit card at the tap and pay contactless transaction device, the user is asked to enter the associated PIN of the debit card to initiate purchasing.

At 210, the transaction device 102 sends the authentication credential and the transaction amount data to the acquirer server 130. At 215, the acquirer server 130 sends the authentication credential and the transaction amount data to the payment server 140. The acquirer server 130 also determines the acquirer account of the merchant and sends the acquirer account details to the payment server 140.

At 220, the payment server 140 sends the authentication credential and the transaction amount data to the issuer server 135 for authentication and authorization. The payment server 140 also sends the payment card details/data of the payment card to the issuer server 135. Further, the payment server 140 identifies the merchant using the acquirer details received from the acquirer server 130 for processing the transaction after successful authentication and authorization.

At 225, the issuer server 135 verifies the authentication credential and performs authorization of the payment card. More specifically, the issuer server 135 verifies the received authentication credential with a stored authentication credential set by the user at the time of registering for the payment card. If the match is successful, the authentication is considered to be successfully performed. If the match fails, the transaction is declined for unsuccessful verification i.e., authentication credential being incorrect. The issuer server 135 performs authorization of the payment card data and the transaction amount data by verifying the card information of the payment card, available balance amount in the user's account against the received transaction amount data, issuer account information and the like. Some non-exhaustive examples of the issuer account information include Bank Identifier Code (BIC), account number, payment card number and the like. Even if the authorization is successful, the transaction is still considered declined because of the identification of the incorrect authentication credential. Accordingly, the issuer server 135 generates a declined transaction notification signal.

At 230, the issuer server 135 sends the declined transaction notification signal to the payment server 140. At 235, the payment server 140 verifies if the user has opted for a dual authentication service. This information may have been stored in a database of the payment server 140 at a previous time. If the user has not opted for the service, the transaction is aborted. However, if the user has opted for the service, the payment server 140 generates a user approval notification signal as part of the service feature.

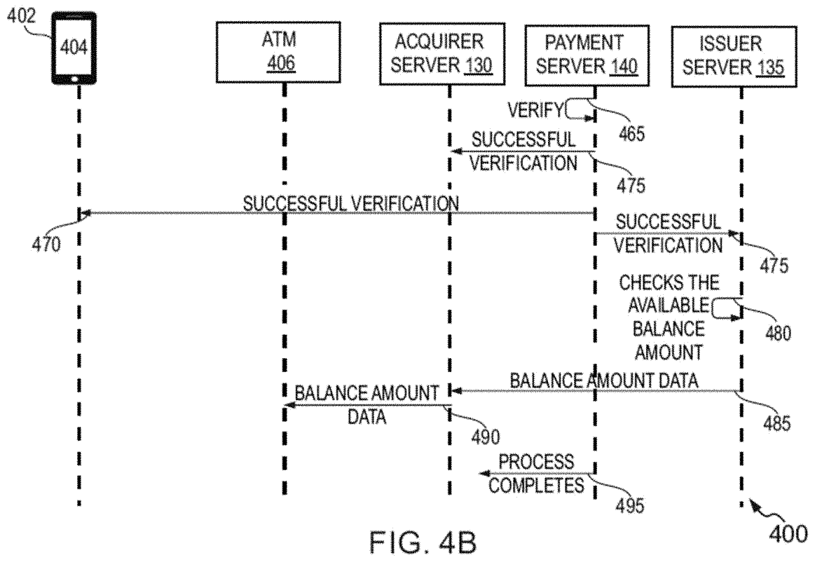

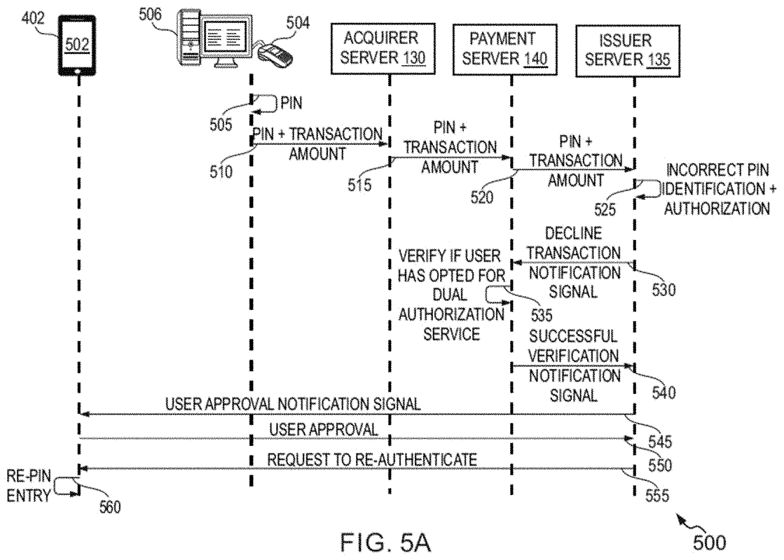

At 240, the payment server 140 sends the user approval notification signal to the user device 104 via the application 106. The user approval notification signal may be sent in a form of a push notification. For example, a pop-up message from the application 106 may be displayed on a display screen of the user device 104 to seek user approval of the wrongly provided authentication signal. Alternatively, the user may be notified via an SMS using the SMS application running on a mobile phone of the user, which may have link to direct the user to the application to response on the message via a dedicated UI. For example, the UI may display the information about the declined transaction such as transaction amount, date, time, place etc. and provide clickable buttons to receive user response of approval or denial of incorrectly provided authentication credential. This is explained in detail later with reference to FIGS. 7A and 7B.

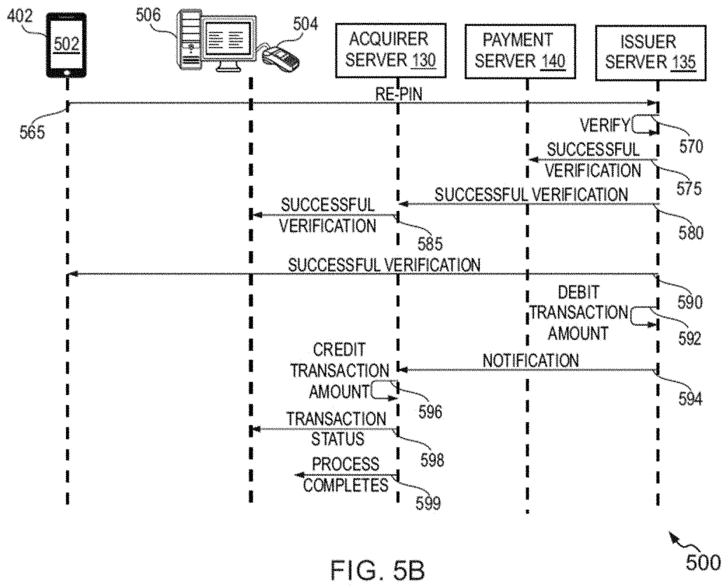

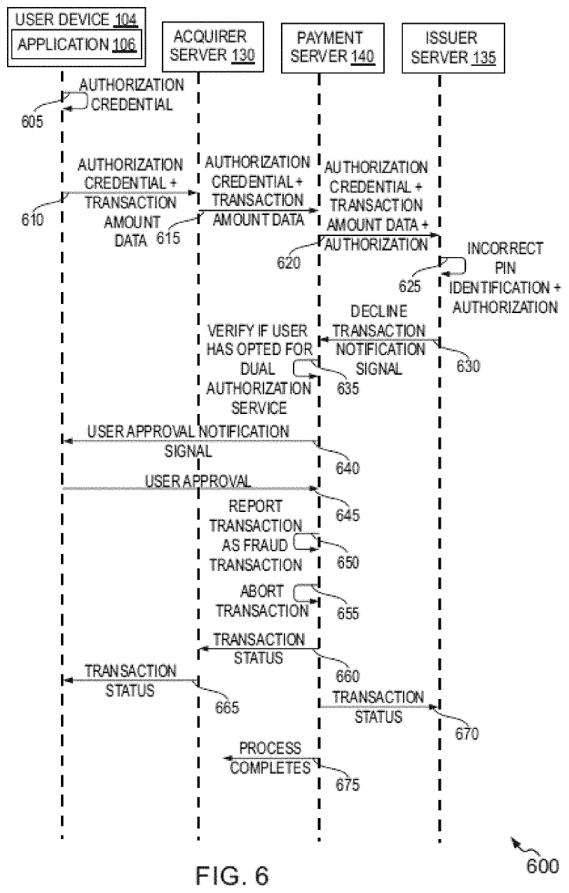

In at least one embodiment, the user approval notification signal is sent to the user device 104 via the application 106 to seek user approval of providing the incorrect authentication credential. In another embodiment, the user approval notification signal is sent to the user device 104 via the application 106 to seek user approval of providing a correct authentication credential by himself. For example, the user has entered a PIN of a debit card at an ATM. The PIN is verified successfully. The user is notified via the application 106 of successful verification of the PIN and to provide a response whether the PIN was entered by the user himself. If the user responds yes, the transaction is processed further. However, if the user responds no, the transaction is reported fraud and is diverted to a fraud management system. Further, the user is asked to provide a re-authentication credential using the application 106 to confirm user identity. This particular feature provides additional security to the user for processing electronic transactions. This is explained further in detail later with reference to FIGS. 8A and 8B. Thus, when the user opts for a dual authentication service, he is benefitted for both types of transactions i.e., re-authenticating a declined transaction and re-authenticating a successfully authenticated transaction.

At 245, the payment server 140 receives, via the application 106, the user approval of providing the incorrect authentication credential. The user provides the approval using a UI of the application 106. At 250, the payment server 140 sends a request to re-authenticate to the user device 104 via the application 106.

At 255, the user provides a re-authentication credential using a UI of the application 106. The application 106 is configured to display a UI using which the user is enabled to select a mode of the re-authentication and provide a re-authentication credential for the selected mode. For example, the user may select processing the declined transaction using another payment card. If the application 106 is the payment application that already has one or more of the payment cards of user stored digitally, then the user may be enabled to select another payment card for which he remembers the correct PIN via a UI of the application 106. Thereafter, the user may be enabled to enter the PIN of the selected payment card in another UI. Alternatively, re-authentication credential can be one of a previously provided authentication credential, a PIN, an MPIN (Mobile PIN), a password, a biometric information, an OTP, a user location and the like.

At 260, the payment server 140 receives the re-authentication credential from the application 106 as entered by the user using the user device 104. At 265, the re-authentication credential is verified by the payment server 140. Considering the above example, the PIN of another payment card may be verified by the payment server 140 based on matching with the original PIN stored in a database. Alternatively, the payment server 140 may send the re-authentication credential to the issuer server 135 for verification. The issuer server 135 may verify the re-authentication credential and, upon successful verification, may notify the payment server 140 of the successful verification.

At 270, the payment server 140 sends a successful verification of the re-authentication credential message to the acquirer server 130. At 275, the acquirer server 130 sends the successful verification of the re-authentication credential message to the transaction device 102. At 280, the payment server 140 sends a successful verification of the re-authentication credential message to the user device 104 via a UI of the application 106. Further, at 285, the payment server 140 sends the successful verification of the re-authentication credential message to the issuer server 135. The re-authentication process of the declined transaction via the application 106 facilitated by the payment server 140 completes at operation 290. As the payment card for which the incorrect PIN has been detected is already authorized by the issuer before the re-authentication process, the transaction is processed normally.

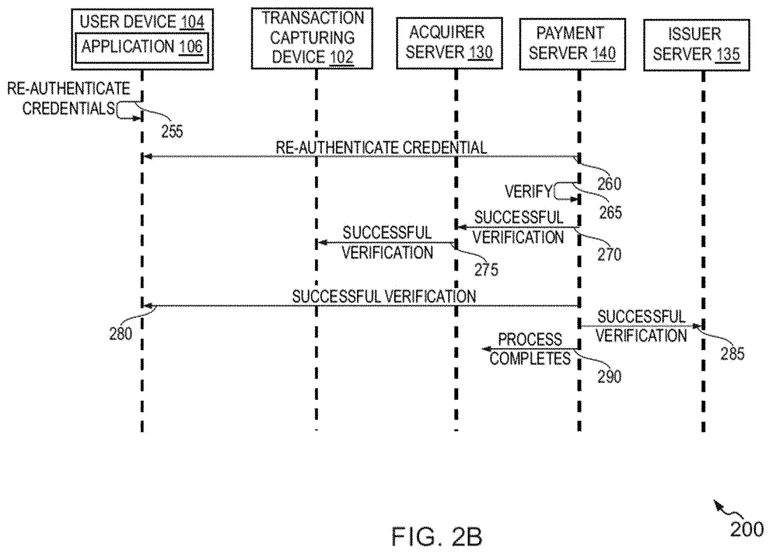

FIGS. 3A-3B collectively represent a sequence flow diagram 300 representing re-authentication of a declined transaction using an application, in accordance with another example embodiment. More specifically, the sequence flow diagram 200 represents re-authentication of a declined financial transaction using the application 106 facilitated by the issuer server 135 of FIG. 1.

At 305, a user enters/provides an authentication credential of a payment card to the transaction capturing device 102 for processing a transaction for a transaction amount. For example, the user wants to withdraw cash 2000 INR from an ATM. Once the user enters the debit card at the ATM, the user is asked to enter the associated PIN of the debit card to initiate withdrawal.

At 310, the transaction device 102 sends the authentication credential and the transaction amount data to the acquirer server 130. At 315, the acquirer server 130 sends the authentication credential and the transaction amount data (i.e., 2000 INR) to the payment server 140. The acquirer server 130 also determines the acquirer account of the merchant and sends the acquirer account details to the payment server 140.

At 320, the payment server 140 sends the authentication credential and the transaction amount data to the issuer server 135 for authentication and authorization. The payment server 140 also sends the payment card details to the issuer server 135. Further, the payment server 140 identifies the merchant using the acquirer details received from the acquirer server 130 for processing the transaction after successful authentication and authorization.

At 325, the issuer server 135 verifies the authentication credential and performs authorization of the payment card. The issuer server 135 verifies the received authentication credential with a stored authentication credential set by the user at the time of registering for the payment card. If the match fails, the transaction is declined because of unsuccessful verification of the authentication credential. The issuer server 135 performs authorization of the payment card data and the transaction amount data by verifying the card information of the payment card, available balance amount in the user's account against the received transaction amount data, issuer account information and the like. Even if the authorization is successful, the transaction is considered declined because of the identification of the incorrect authentication credential. Accordingly, the issuer server 135 generates a declined transaction notification signal.

At 330, the issuer server 135 sends the declined transaction notification signal to the payment server 140. At 335, the payment server 140 verifies if the user has opted for a dual authentication service. If the user has not opted for the service, the payment server 140 notifies the issuer server 135 of the same and the transaction is aborted.

However, if the user has opted for the service, at 340, the payment server 140 sends a successful verification notification signal about the user opting for the dual authentication service to the issuer server 135. Accordingly, the issuer server 135 generates a user approval notification signal as part of the service feature.

At 345, the issuer server 135 sends the user approval notification signal to the user device 104 via the application 106. The user approval notification signal may be sent in the form of a push notification. For example, a pop-up message from the application 106 may be displayed on a display screen of the user device 104 to seek user approval of wrongly provided authentication signal. For example, the UI may display the information about the declined transaction such as transaction amount, date, time, place etc. and provide clickable buttons to receive user response of approval or denial of the incorrectly provided authentication credential. As explained with reference to FIG. 2A, the user approval notification signal may also be sent to the user device 104 via the application 106 to seek user approval of a successfully verified authentication credential to provide additional security.

At 350, the issuer server 135 receives, via the application 106, the user approval of providing the incorrect authentication credential. The user provides the approval using a UI of the application 106. At 355, the issuer server 135 sends a request to re-authenticate to the user device 104 via the application 106.

At 360, the user provides a re-authentication credential using a UI of the application 106. The application 106 is configured to display a UI using which the user is enabled to select a mode of the re-authentication and provide a re-authentication credential for the selected mode. For example, the user may select processing the declined transaction using a geographic location of the user. The application 106 may be enabled to access user device's location using a GPS signal being emitted from the user device 104. As the application 106 already has transaction details such as place, date, time and transaction amount of the declined transaction, the application 106 may be able to match the user location with the location of the transaction. If both the locations match, the result may be considered to authenticate the user as the one performing the transaction.

At 365, the issuer server 135 receives the re-authentication credential from the application 106 as entered by the user using the user device 104. At 370, the re-authentication credential is verified by the issuer server 135. Upon successful verification, at 375, the issuer server 135 notifies the payment server 140 of the successful verification.

At 380, the issuer server 135 sends a successful verification of the re-authentication credential message to the acquirer server 130. At 385, the acquirer server 130 sends the successful verification of the re-authentication credential message to the transaction device 102. At 390, the issuer server 135 sends a successful verification of the re-authentication credential message to the user device 104 via a UI of the application 106. The re-authentication process of the declined transaction via the application 106 facilitated by the issuer server 135 completes at operation 395. The transaction is processed further normally after successful re-authentication verification.

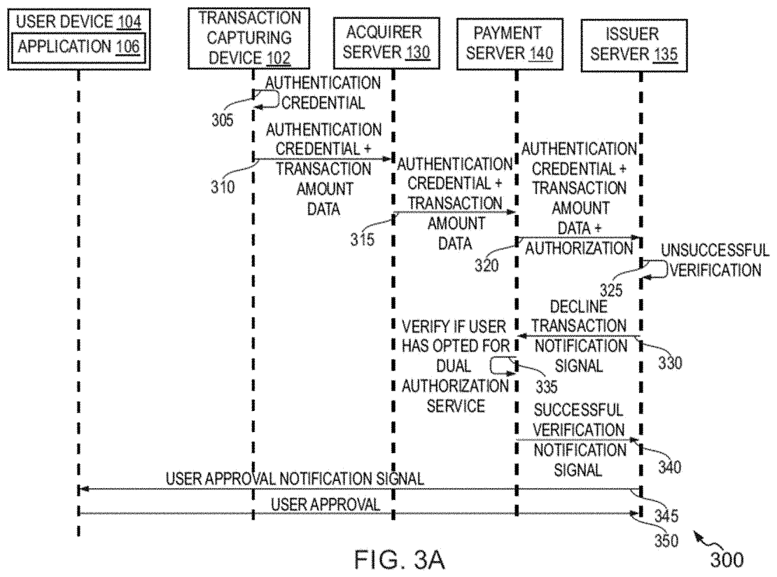

FIGS. 4A-4B, collectively represent a sequence flow diagram 400 representing processing of a declined non-financial transaction using an application, in accordance with an example embodiment. More specifically, the sequence flow diagram 400 represents re-authentication of a declined non-financial transaction using a payment application 404 facilitated by the payment server 140 of FIG. 1.

At 405, a user (not shown) enters a PIN of a debit card to an ATM 406 for making an account balance inquiry (hereinafter referred to as inquiry data) for a user account. The ATM 406 is capable of capturing PIN for the debit card of the user for processing financial and non-financial transactions.

At 410, the ATM 406 sends the PIN and the enquiry data to the acquirer server 130. At 415, the acquirer server 130 sends the PIN and the enquiry data to the payment server 140.

At 420, the payment server 140 sends the PIN and the enquiry data to the issuer server 135 for authentication and authorization. The payment server 140 also sends the debit card details to the issuer server 135.

At 425, the issuer server 135 verifies the PIN and performs authorization of the debit card. The PIN being incorrectly entered by the user, the verification results in unsuccessful authentication. The issuer server 135 performs authorization of the debit card data by verifying the card information of the debit card. The transaction is considered declined because of the identification of the incorrect PIN. Accordingly, the issuer server 135 generates a declined transaction notification signal.

At 430, the issuer server 135 sends the declined transaction notification signal to the payment server 140. At 435, the payment server 140 verifies if the user has opted for a dual authentication service. If the user has opted for the service, the payment server 140 generates a user approval notification signal by activating the payment application 404.

At 435, the payment server 140 sends the user approval notification signal to a user device i.e., a smart phone 402 via the payment application 404 (e.g., the application 106 of FIG. 1). A pop-up message from the payment application 404 may be displayed on a display screen of the smart phone 402 to seek user approval of wrongly provided authentication signal.

At 440, the payment server 140 receives, via the payment application 404, the user approval of providing the incorrect PIN. The user provides the approval using a UI of the payment application 404. At 445, the payment server 140 sends re-authentication request to the smart phone 402 via the payment application 404.

At 450, the user provides a biometric information (e.g., a fingerprint or an iris scan) as a re-authentication credential using a UI of the payment application 404. At 455, the payment server 140 receives the biometric information from the payment application 404 as scanned by the user using the smart phone 402.

At 460, the biometric information is verified by the payment server 140. The user may have provided a fingerprint scan to be used as a re-authentication credential at the time of registering for the dual authentication service via the payment application 404. The payment server 140 is configured to store the fingerprint scan of the user in a database and retrieve it at the time of verifying the re-authentication credential.

At 465, payment server 140 sends a successful verification of the biometric information to the acquirer server 130. At 470, the payment server 140 sends a successful verification of the biometric information message to the smart phone 402 via a UI of the payment application 404.

At 475, the payment server 140 sends a successful verification of the biometric information to the issuer server 135. At 480, the issuer server 135 checks available balance amount in the user's account for responding to the enquiry data.

At 485, the issuer server 135 sends a balance amount data to the acquirer server 130. At 490, the acquirer server 130 sends the balance amount data to the ATM 406. The re-authentication process of the declined non-financial transaction via the payment application 404 facilitated by the payment server 140 completes at operation 495.

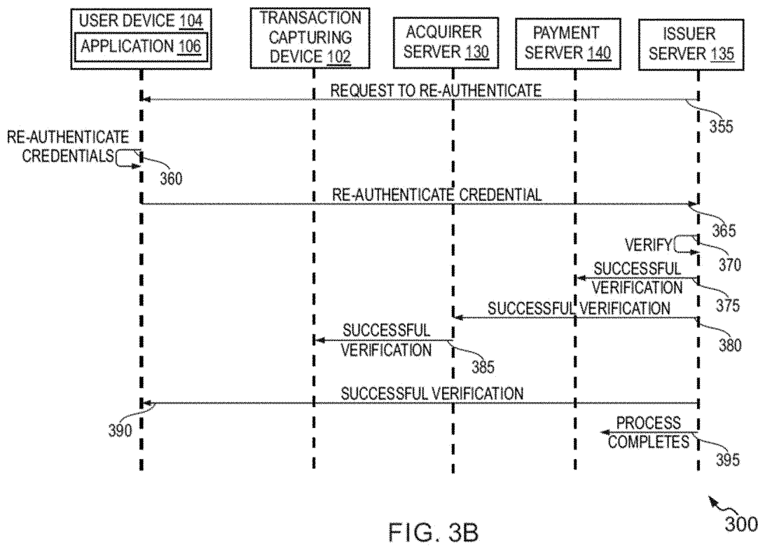

FIGS. 5A-5B are a sequence flow diagram 500 representing processing of a declined transaction using an application, in accordance with another example embodiment. More specifically, the sequence flow diagram 500 represents re-authentication of a declined financial transaction using a payment application 502 facilitated by the issuer server 135 of FIG. 1.

At 505, a user enters a PIN of a credit card to a POS terminal 504 connected to a merchant desktop computer 506 for processing a payment transaction for a transaction amount. For example, the user wants to purchase products from a merchant facility worth 5000 INR using a credit card. Once the user inserts or swipes the credit card at the POS terminal 504, the user is asked to enter the associated PIN of the credit card to initiate the payment transaction.

At 510, the POS terminal 504 sends the PIN and the transaction amount data to the acquirer server 130. At 515, the acquirer server 130 sends the PIN and the transaction amount data (i.e., 5000 INR) to the payment server 140. The acquirer server 130 also determines the acquirer account of the merchant and sends the acquirer account details to the payment server 140.

At 520, the payment server 140 sends the PIN and the transaction amount data to the issuer server 135 for authentication and authorization. The payment server 140 also sends the credit card details to the issuer server 135. Further, the payment server 140 identifies the merchant using the acquirer details received from the acquirer server 130 for processing the transaction after successful authentication and authorization.

At 525, the issuer server 135 verifies the PIN and performs authorization of the credit card. The issuer server 135 verifies the received PIN with a stored PIN set by the user at the time of registering for the credit card. If the match fails, the transaction is declined because of unsuccessful verification as the PIN is incorrect. The issuer server 135 performs authorization of the credit card data and the transaction amount data by verifying the card information of the credit card, available balance amount in the user's account against the received transaction amount data, issuer account information and the like. The transaction is considered declined because of the identification of the incorrect PIN. Accordingly, the issuer server 135 generates a declined transaction notification signal.

At 530, the issuer server 135 sends the declined transaction notification signal to the payment server 140. At 535, the payment server 140 verifies if the user has opted for a dual authentication service.

If the user has opted for the dual authentication service, at 540, the payment server 140 sends a successful verification notification signal about the user opting for the dual authentication service to the issuer server 135.

At 545, the issuer server 135 sends a user approval notification signal to the smart phone 402 via the payment application 502. A pop-up message from the payment application 502 may be displayed on a display screen of the smart phone 402 to seek user approval. As explained with reference to FIG. 2A, the user approval notification signal may also be sent to the smart phone 402 via the payment application 502 to seek user approval of a successfully verified PIN.

At 550, the issuer server 135 receives, via the payment application 502, the user approval of providing the incorrect PIN. The user provides the approval using a UI of the payment application 502. At 555, the issuer server 135 sends a request to re-authenticate to the smart phone 402 via the payment application 502.

At 560, the user provides a re-PIN using a UI of the payment application 502. The payment application 502 is configured to display a UI using which the user is enabled to provide a re-PIN.

At 565, the issuer server 135 receives the re-PIN from the payment application 502 as entered by the user using the smart phone 402. At 570, the re-PIN is verified by the issuer server 135. Upon successful verification, at 575, the issuer server 135 notifies the payment server 140 of the successful verification.

At 580, the issuer server 135 sends a successful verification of the re-PIN message to the acquirer server 130. At 585, the acquirer server 130 sends the successful verification of the re-PIN message to the POS terminal 504. At 590, the issuer server 135 sends a successful verification of the re-PIN message to the smart phone 402 via a UI of the payment application 502. At 592, the issuer server 135 debits the transaction amount from the issuer account of the user. At 594, the issuer server 135 notifies the acquirer server 130 of debiting of the transaction amount. At 596, the acquirer server 130 credits the transaction amount into an acquirer account of the merchant. At 598, the acquirer server 130 sends a transaction status to the POS terminal 504. The payment transaction process completes at step 599.

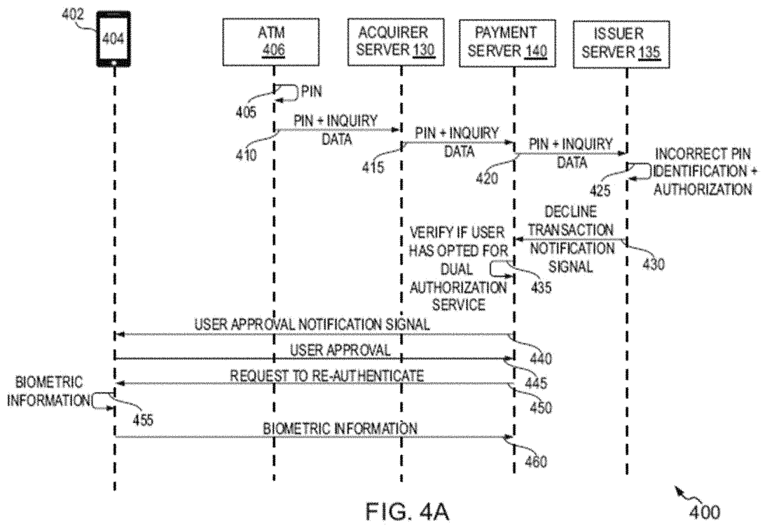

FIG. 6 represents a sequence flow diagram 600 representing reporting a declined transaction as a fraud transaction using an application, in accordance with an example embodiment. More specifically, the sequence flow diagram 600 represents user denial of providing incorrect authentication credential at the transaction device 102 using the application 106 facilitated by the payment server 140 of FIG. 1.

At 605, a user provides an authentication credential (e.g., a password) of a payment card (credit card) via a merchant website (not shown) running in the user device 104 (e.g., transaction capturing device 102) for processing an e-commerce transaction for a transaction amount.

At 610, the user device 104 sends the authentication credential and the transaction amount data to the acquirer server 130. At 615, the acquirer server 130 sends the authentication credential and the transaction amount data to the payment server 140.

At 620, the payment server 140 sends the authentication credential and the transaction amount data to the issuer server 135 for authentication and authorization. The payment server 140 also sends the payment card details to the issuer server 135.

At 625, the issuer server 135 verifies the authentication credential and performs authorization of the payment card. If the match fails, the transaction is declined for verification of the authentication credential being incorrect. The issuer server 135 also performs authorization by verifying the card information of the payment card, available balance amount in the user's account against the received transaction amount data, issuer account information and the like. Accordingly, the issuer server 135 generates a declined transaction notification signal.

At 630, the issuer server 135 sends the declined transaction notification signal to the payment server 140. At 635, the payment server 140 verifies if the user has opted for a dual authentication service. If yes, the payment server 140 generates a user approval notification signal.

At 640, the payment server 140 sends the user approval notification signal to the user device 104 via the application 106. The user approval notification signal may be sent in the form of a push notification via a UI of the application 106. The UI may display the information about the declined transaction such as transaction amount, date, time, place etc. and provide clickable buttons to receive user response of approval or denial of the incorrectly provided authentication credential.

At 645, the payment server 140 receives, via the application 106, a user denial of providing the incorrect authentication credential. At 650, the payment server 140 reports the declined transaction as a fraud transaction. At 655, the payments server aborts the declined transaction.

At 660, the payment server 140 sends a transaction status to the acquirer server 130. At 665, the acquirer server 130 sends the transaction status to the user device 104. Alternatively, the payment server 140 may send the transaction status to the user device 104 via a UI of the application 106. Further, at 670, the payment server 140 sends the transaction status to the issuer server 135. The process completes at operation 675.

FIG. 7A represents a User Interface (UI) 700A for seeking a user approval of incorrectly providing an authentication credential via an application, in accordance with an example embodiment. An application such as the payment application 404 is shown running in a user device such as the smart phone 402. The UI 700A displays an information field 702 displaying text, ‘a transaction is declined for a credit card ending xxxx xxxx xxxx 4253 at 12:30 pm, 29^{th} November at a grocery store XYZ for a transaction amount 1000 INR’. Clickable buttons 704 and 706, respectively, labelled as ‘approve’ and ‘deny’ are included for receiving a user approval. If the user himself has provided a wrong authentication credential, the user approves the same by clicking the button 704. The payment application 404 receives the user approval and forwards the approval to the payment server 140. The payment server 140 is configured to send a request to re-authenticate to the smart phone 402 via the payment application 404. This is explained in detail with reference to FIG. 7B hereinafter.

FIG. 7B represents a User Interface (UI) 700B for displaying modes of re-authentication facilitated via an application for user selection, in accordance with an example embodiment. The payment server 140, via the UI 700B of the payment application 404, is configured to display a header 708 displaying text ‘select a mode of re-authentication’. The header 708 is accompanied by a plurality of re-authentication modes 710 exemplarily displayed as ‘PIN’ ‘biometric’, ‘MPIN’, ‘GPS location’, ‘use another card’. The UI 700B displays a user selection of the mode ‘PIN’. The user clicks a button 712 labeled as ‘submit’ to submit the selection of ‘PIN’ as the preferred mode of re-authentication using the UI 700B. Submission of the re-authentication mode selection directs the user to another UI (not shown) using which the user is enabled to re-enter the correct PIN for the declined transaction. In one example embodiment, if the re-entered PIN is again incorrect, the user is notified of the same via the payment application 404 and the transaction process is aborted. In another example embodiment, the user may be allowed a pre-defined number of attempts to re-authenticate the declined transaction via the payment application 404.

FIG. 8A represents a User Interface (UI) 800A for seeking a user approval of providing a correct authentication credential via an application, in accordance with an example embodiment. The payment application 404 is shown running in the smart phone 402. The UI 800A displays an information field 802 displaying text, ‘a transaction is attempted for a credit card ending xxxx xxxx xxxx 4253 at 12:30 pm, 29^{th} November at a grocery store XYZ for a transaction amount 1000 INR’. The authentication credential is already verified by the issuer server 135 as being correct. Clickable buttons 804 and 806, respectively, labelled as ‘approve’ and ‘deny’ are included for receiving a user approval. If the user himself has provided the authentication credential, the user approves the same by clicking the button 804. The payment application 404 receives the user approval and forwards the approval to the payment server 140. The payment server 140 is configured to send a request to re-authenticate to the smart phone 402 via a UI 800B of the payment application 404 to verify the user identity and authenticity.

FIG. 8B represents a User Interface (UI) 800B for displaying modes of re-authentication facilitated via an application for user selection, in accordance with an example embodiment. The payment server 140, via the UI 800B of the payment application 404, is configured to display a header 808 displaying text ‘select a mode of re-authentication’. The header 808 is accompanied by a plurality of re-authentication modes 810 exemplarily displayed as ‘PIN’ ‘biometric’, ‘MPIN’, ‘GPS location’, ‘use another card’. The UI 800B displays a user selection of the mode ‘biometric’. The user clicks a button 812 labeled as ‘submit’ to submit the selection of ‘biometric’ as the preferred mode of re-authentication using the UI 800B. Submission of the re-authentication mode selection directs the user to another UI (not shown) using which the user is enabled to scan a fingerprint or an iris. Upon a successful verification of the biometric information, the re-authentication process completes, and the transaction is processed further.

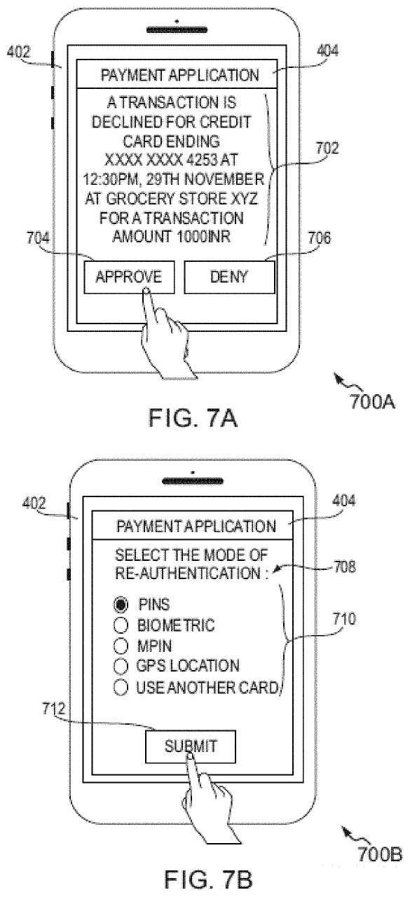

In at least one embodiment, the dual authentication service provides a unique feature of extension of time provided to the user to complete the re-authentication process. In case of a session timeout (i.e., a pre-determined time period within which the transaction needs to be completed) while re-authenticating, the payment server 140 sends a reset time request to the acquirer server 130 if the issuer has opted for the dual authentication value added service. This is explained in detail with reference to FIGS. 9A and 9B hereinafter.

FIG. 9A and FIG. 9B collectively represent UIs 900A and 900B for electronically facilitating an extension of time for performing re-authentication process, in accordance with an example embodiment. The UI 900A is displayed on a display screen of a transaction capturing device such as the POS terminal 504. The UI 900A displays a header 902 displaying text ‘extended session timer: 00:01:00’. The timer may be displayed in hours (HH), minutes (MM) and seconds (SS) format. The UI 900A further displays a PIN 904 (four-digit PIN exemplarily displayed as xxxx) as originally entered by the user. An information field 906 displays text, ‘transaction declined due to wrong PIN’.

As explained in foregoing figures, the user is notified by an application in the user device about the wrong PIN and allowed to re-authenticate the transaction by providing a re-authentication credential. The user enters the re-authentication credential in a UI of the application and upon successful verification of the re-authentication credential, the transaction is successfully completed. The acquirer server 130 notifies the transaction device i.e., the POS terminal 504 of successful transaction completion. This is displayed via the UI 900B.

The UI 900B is displayed on the display screen of the POS terminal 504. The UI 900B displays a header 908 displaying text ‘extended session timer: 00:00:30’. As shown, there are still remaining 30 seconds as compared to the time of the header 902 of UI 900A. The UI 900B further displays an information field 910 displaying text, ‘successful transaction’. The extension of time helps the user to complete the transaction without keeping track of session timer.

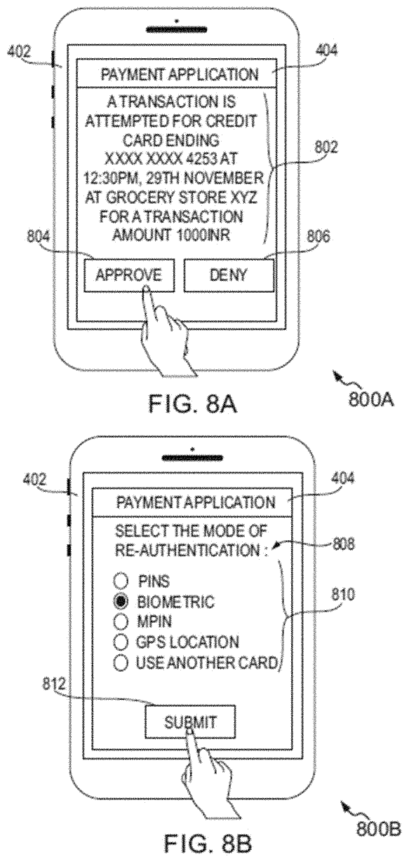

FIG. 10 illustrates a flow diagram of a method 1000 for processing a declined transaction, in accordance with an example embodiment. More specifically, the method 1000 for processing a declined transaction by re-authenticating the declined transaction via an application is disclosed. The method 1000 depicted in the flow diagram may be executed by, for example, the at least one server system such as the acquirer server 130, the issuer server 135, and the payment server 140 explained with reference to FIG. 1. Operations of the method 1000, and combinations of operation in the method 1000, may be implemented by, for example, hardware, firmware, a processor, circuitry and/or a different device associated with the execution of software that includes one or more computer program instructions. The operations of the method 1000 are described herein with help of the servers 130, 135, or 140. It is noted that the operations of the method 1000 can be described and/or practiced by using a system other than these server systems. The method 1000 starts at operation 1002.

At 1002, the method 1000 includes a declined transaction notification signal about an identification of an authentication credential of a payment card associated with a user as incorrect. The authentication credential is provided by the user for initiating a transaction in a transaction capturing device.

At 1004, the method 1000 includes, verifying, by the server system, if the user has opted for a dual authentication service. The dual authentication service includes facilitating re-authentication of the declined transaction via an application.

If the user has opted for the dual authentication service, at 1006, the method 1000 includes sending, by the server system, a user approval notification signal to a user device via the application. The user approval notification signal seeks a user approval of providing the incorrect authentication credential.

At 1008, the method 1000 includes receiving, via the application, by the server system, the user approval of providing the incorrect authentication credential.

At 1010, the method 1000 includes electronically facilitating, by the server system, re-authentication of the transaction via the application. Re-authentication includes requesting the user to provide a re-authentication credential via the application.

At 1012, the method 1000 includes electronically facilitating, by the server system, a completion of the declined transaction based on verification of the re-authentication credential. The method 1000 stops at operation 1012.

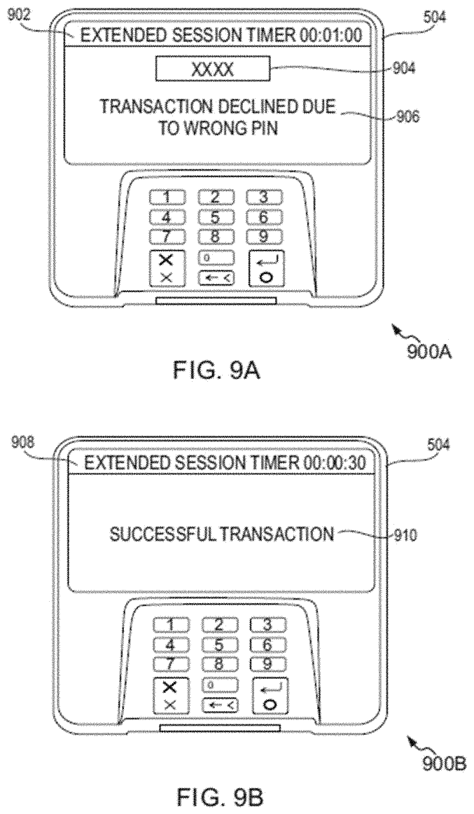

FIG. 11 illustrates a flow diagram of another method 1100 for processing a declined transaction, in accordance with an example embodiment. More specifically, the method 1100 for processing a declined transaction by re-authenticating the declined transaction via an application is disclosed. The method 1100 depicted in the flow diagram may be executed by, for example, the at least one server system such as the acquirer server 130, the issuer server 135, and the payment server 140 explained with reference to FIG. 1. Operations of the method 1100, and combinations of operation in the method 1100, may be implemented by, for example, hardware, firmware, a processor, circuitry and/or a different device associated with the execution of software that includes one or more computer program instructions. The operations of the method 1100 are described herein with help of the servers 130, 135, or 140. It is noted that the operations of the method 1100 can be described and/or practiced by using a system other than these server systems. The method 1100 starts at operation 1102.

At 1102, the method 1100 includes identifying, by a server system associated with a payment network, an authentication credential of a payment card associated with a user as incorrect. The authentication credential is provided by the user for initiating a transaction in a transaction capturing device.

At 1104, the method 1100 includes, declining, by the server system, the transaction based on identification of the incorrect authentication credential provided by the user.

At 1106, the method 1100 includes sending, by the server system, a user approval notification signal to a user device via an application. The user approval notification signal seeks a user approval of providing the incorrect authentication credential.

At 1108, the method 1100 includes receiving, via the application, by the server system, the user approval of providing the incorrect authentication credential.

At 1110, the method 1100 includes electronically facilitating, by the server system, re-authentication of the transaction via the application, wherein re-authentication includes requesting the user to provide a re-authentication credential via the application.

At 1112, the method 1100 includes electronically facilitating, by the server system, a completion of the declined transaction based on verification of the re-authentication credential. The method 1100 stops at operation 1112.

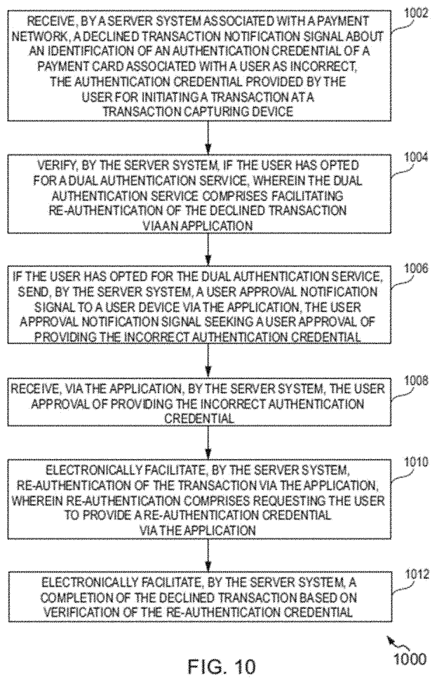

FIG. 12 is a simplified block diagram of a server system 1200, in accordance with one embodiment of the present disclosure. Examples of the server system 1200 include, but are not limited to, the acquirer server 130, the issuer server 135, and the payment server 140. The server system 1200 includes a computer system 1205 and a database 1210.

The computer system 1205 includes at least one processor 1215 for executing instructions. Instructions may be stored in, for example, but not limited to, a memory 1220. The processor 1215 may include one or more processing units (e.g., in a multi-core configuration). The processor 1215 is operatively coupled to a communication interface 1225 such that the computer system 1205 is capable of communicating with a remote device such as a user device 1230 (e.g., the user device 104), a transaction capturing device 1235 (e.g., the transaction device 102) or communicating with any entity within the payment network 145.

The processor 1215 may also be operatively coupled to the database 1210. The database 1210 is any computer-operated hardware suitable for storing and/or retrieving data, such as, but not limited to, transaction data generated as part of sales activities conducted over the bankcard network including data relating to merchants, account holders or customers, and purchases. The database 1210 may also store information related to a plurality of users' payment accounts. Each user account data includes at least one of a user name, a user address, an account number, a contact information, PIN, and other account identifiers. The database 1210 may also store device identifiers, platform IDs of the users etc.

The database 1210 may also store a merchant identifier that identifies each merchant registered to use the payment network 145, and instructions for settling transactions including merchant bank account information (e.g., a plurality of payment accounts related to the merchant interfaces associated with merchants). The database 1210 may further include issuer account information, BINs, transaction identifier data, authentication credential, re-authentication credential etc. The database 1210 may include multiple storage units such as hard disks and/or solid-state disks in a redundant array of inexpensive disks (RAID) configuration. The database 1210 may include a storage area network (SAN) and/or a network attached storage (NAS) system.

In some embodiments, the database 1210 is integrated within the computer system 1205. For example, the computer system 1205 may include one or more hard disk drives as the database 1210. In other embodiments, the database 1210 is external to the computer system 1205 and may be accessed by the computer system 1205 using a storage interface 1240. The storage interface 1240 is any component capable of providing the processor 1215 with access to the database 1210. The storage interface 1240 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1215 with access to the database 1210.

The processor 1215 is configured to receive an authentication credential of a payment card provided by a user for initiating a transaction in the transaction capturing device 1235 via the communication interface 1225. The transaction is at least one of a non-financial transaction and a financial transaction including an e-commerce transaction. The processor 1215 is configured to perform authentication and authorization. The processor 1215 is configured to validate the payment card data using the associated card information stored in the database 1210. If the transaction is a financial transaction, the processor 1215 is further configured to approve the transaction amount data by verifying against the available balance in the issuer account of the user, as stored in the database 1210. The processor 1215 is configured to generate a declined transaction notification signal upon unsuccessful verification of the authentication credential based on matching with a stored authentication credential in the database 1210.

The processor 1215 is configured to verify if the user has opted for a dual authentication service that facilitates re-authentication of the declined transaction via an application. The processor 1215 is configured to send a user approval notification signal to the user device 1230 via the application to seek a user approval of providing the incorrect authentication credential. The processor 1215 is configured to receive the user approval providing the incorrect authentication credential from the user device 1230 via the communication interface 1225. The communication interface 1225, via the application, is configured to cause display of user interfaces on the user device 1230 to enable the user to re-authenticate a declined transaction by providing a re-authentication credential. The processor 1215 is configured to verify the re-authentication credential with a stored re-authentication credential in the database 1210. Upon successful verification of the re-authentication credential, the processor 1215 is configured to facilitate completion of the declined transaction.

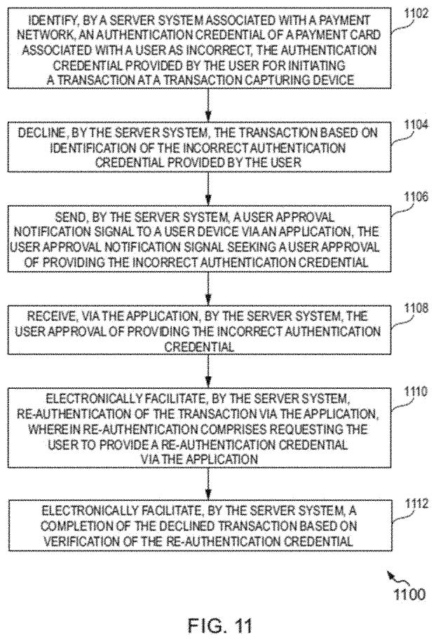

FIG. 13 is a simplified block diagram of an issuer server 1300, in accordance with one embodiment of the present disclosure. The issuer server 1300 is an example of the issuer server 135 of FIG. 1 or may be embodied in the issuer server 135. The issuer server 1300 is associated with an issuer bank/issuer, in which a user may have an account. The issuer server 1300 includes a processing module 1305 operatively coupled to a memory 1310, an authorization module 1315, and a communication module 1320. The components of the issuer server 1300 provided herein may not be exhaustive, and that the issuer server 1300 may include more or fewer components than those depicted in FIG. 13. Further, two or more components may be embodied in one single component, and/or one component may be configured using multiple sub-components to achieve the desired functionalities. Some components of the issuer server 1300 may be configured using hardware elements, software elements, firmware elements and/or a combination thereof.

The processing module 1305 is capable of executing the stored machine executable instructions of an application 1330 (e.g., the application 106 of FIG. 1) in the memory 1310 or within the processing module 1305 or any storage location accessible to the processing module 1305. The communication module 1320 is configured to cause display of user interfaces in a remote device 1325 (e.g., the user device 1230). Via the application 1330, the processing module 1305 is configured to provide a plurality of modes of re-authentication for user selection for performing a re-authentication of a declined transaction. Some non-exhaustive examples of the plurality of re-authentication modes include PIN, MPIN, biometric information (e.g., a fingerprint for fingerprint recognition, an iris for iris recognition, a voice for voice recognition, a facial image for facial recognition, a hand geometry etc.), user location, use of another payment card etc. The processing module 1305 is further configured to communicate with one or more other remote devices using the communication module 1320 over the communication network 150 or the payment network 145 of FIG. 1. The examples of the remote device 1325 include the payment server 140, the acquirer server 130, a merchant server, the transaction capturing device 1235, other computing systems of issuer and the payment network 145 and the like. The communication module 1320 is capable of facilitating such operative communication with the remote devices and cloud servers using API (Application Program Interface) calls.

Additionally, the memory 1310 stores information related to, contact information of the user, identification information of the user, bank account number, BICs, payment card details, internet banking information, PIN, mobile personal identification number (MPIN) for mobile banking and the like. The PIN is a four-digit identification code issued by the issuer bank of the user while registering for electronic payment transactions or while issuing the payment card to the user. For example, the PIN may be issued for swipe-based transactions, mobile banking, internet banking, and the like. The PIN is needed to be verified for authentication of the user's identity and association with the issuer bank to process the payment transaction. This information is retrieved by the processing module 1305 for cross-verification during transactions.

The processing module 1305, in conjunction with the authorization module 1315, is configured to validate the payment card data of the payment card possessed by the user as received from the payment server 140 via the communication module 1320. Additionally, the processing module 1305 is configured to verify the PIN (e.g., whether the four-digit numeric code matches the PIN issued by the issuer), the sufficient funds in the issuer account against the transaction amount and the like. Upon successful authorization of the payment card information and the cardholder only, the transaction is processed further by the processing module 1305.

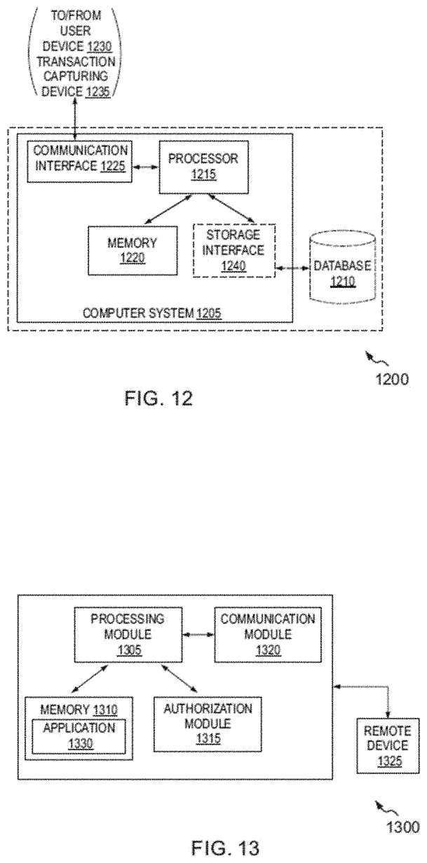

FIG. 14 is a simplified block diagram of an acquirer server 1400, in accordance with one embodiment of the present disclosure. The acquirer server 1400 is associated with the acquirer of a merchant where the merchant has established an account to accept payment performed using the payment card. The acquirer server 1400 is an example of the acquirer server 130 of FIG. 1 or may be embodied in the acquirer server 130. The acquirer server 1400 includes a processing module 1405 communicably coupled to a merchant database 1410 and a communication module 1415. The components of the acquirer server 1400 provided herein may not be exhaustive, and that the acquirer server 1400 may include more or fewer components than those depicted in FIG. 14. Further, two or more components may be embodied in one single component, and/or one component may be configured using multiple sub-components to achieve the desired functionalities. Some components of the acquirer server 1400 may be configured using hardware elements, software elements, firmware elements and/or a combination thereof.

The merchant database 1410 includes data related to merchant, such as, but not limited to, a merchant primary account number (PAN), a merchant name, a merchant category code (MCC), a merchant city, a merchant postal code, a merchant brand name, a merchant ID and the like. The processing module 1405 is configured to use the merchant ID to identify the merchant during the normal processing of payment transactions, adjustments, chargebacks, end-of-month fees and so forth. The merchant ID is different from other merchant account numbers, particularly from those that identify merchants to the equipments (e.g., the POS terminals or any other merchant electronic devices/interfaces) they use for processing transactions. A merchant with a single merchant processing account number may use several terminals at one location, resulting in one merchant ID and several Terminal Identification numbers (TIDs). The processing module 1405 may be configured to store and update such merchant information in the merchant database 1410 for later retrieval.

In an embodiment, the communication module 1415 is capable of facilitating operative communication with a remote device 1420 (e.g., the issuer server 1300, and/or the payment server 140) using API calls. The communication may be achieved over the communication network 150. For example, the processing module 1405 may receive an authentication request signal that includes authentication credential from the transaction capturing device 1235 via the communication module 1415. The processing module 1405 may retrieve merchant PAN from the merchant database 1410 to credit the purchase amount in the acquirer account of the merchant in case of a financial transaction. The processing module 1405 is configured to send a notification of a transaction status of the re-authenticated declined transaction to the transaction capturing device 1235 and the user device 1230.

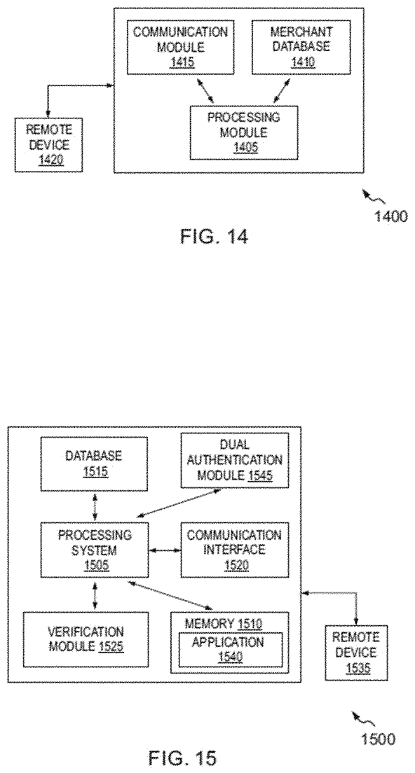

FIG. 15 is a simplified block diagram of a payment server 1500, in accordance with one embodiment of the present disclosure. The payment server 1500 may correspond to the payment server 140 of FIG. 1. As explained with reference to FIG. 1, the payment server 140 is associated with a payment network 145. The payment network 145 may be used by a merchant server, the issuer server 1300, and the acquirer server 1400 as a payment interchange network. The payment server 1500 includes a processing system 1505 configured to extract programming instructions from a memory 1510 to provide various features of the present disclosure. The components of the payment server 1500 provided herein may not be exhaustive, and that the payment server 1500 may include more or fewer components than those depicted in FIG. 15. Further, two or more components may be embodied in one single component, and/or one component may be configured using multiple sub-components to achieve the desired functionalities. Some components of the payment server 1500 may be configured using hardware elements, software elements, firmware elements and/or a combination thereof.

In an embodiment, the processing system 1505 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The processing system 1505 is capable of executing the stored machine executable instructions of an application 1540 (e.g., the application 106 of FIG. 1) in the memory 1510 or within the processing module 1305 or any storage location accessible to the processing system 1505. The memory 1510 is also configured to store machine executable instructions to be accessed by the processing system 1505. The memory 1510 can be any type of storage accessible to the processing system 1505. For example, the memory 1510 may include volatile or non-volatile memories, or a combination thereof. In some non-limiting examples, the memory 1510 can be four to sixty-four Gigabytes (GB) of Dynamic Random Access Memory (“DRAM”) or Static Random Access Memory (“SRAM”). In addition, some examples may include supplementary flash memory installed via a PCMCIA slot.

A dual authentication module 1545 is configured to facilitate a dual authentication service to the user and the issuer. The processing system 1505, in conjunction with the dual authentication module 1545, is configured to perform dual authentication of each transaction of a registered user irrespective of the authentication credential being successfully verified. The communication interface 1520 is configured to cause display of user interfaces in a remote device 1535 (e.g., the user device 1230) for enabling a user to approve or deny a declined transaction. If the transaction is approved, the user is enabled to re-authenticate the declined transaction by providing a re-authentication credential via a UI displayed by the communication interface 1520. If the transaction is denied, the transaction is forwarded to a fraud management system by the processing system 1505. The communication may be achieved through API calls, without loss of generality. The processing system 1505 electronically facilitates extension of time for completing the re-authentication process. An authentication credential and a re-authentication credential are stored in a database 1515 and retrieved during corresponding authentication and re-authentication processes.

A verification module 1525 verifies the re-authentication credential received via the communication interface 1520 from the user device 1230. Via the communication interface 1520, the processing system 1505 sends a successful verification notification signal of the re-authentication of the declined transaction to the acquirer server 1400. the issuer server 1300 and the user device 1230.

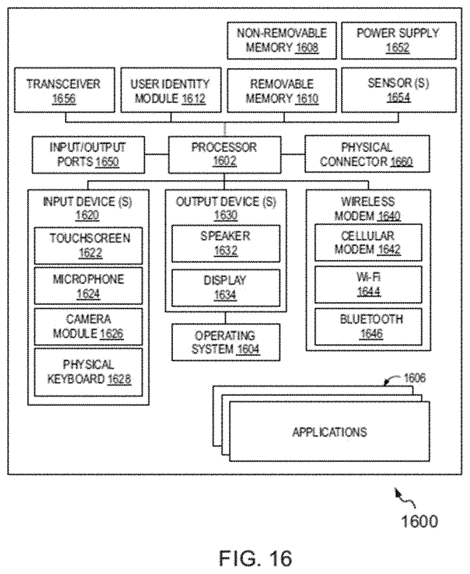

FIG. 16 shows simplified block diagram of a user device 1600 capable of implementing the various embodiments of the present disclosure. For example, the user device 1600 may correspond to the user device 104 of FIG. 1. The user device 1600 is depicted to include one or more applications, such as a merchant application or a payment application. The applications are capable of communicating with any of the servers 130, 135, and 140 for completing a declined transaction by re-authentication using an application.

It should be understood that the user device 1600 as illustrated and hereinafter described is merely illustrative of one type of device and should not be taken to limit the scope of the embodiments. As such, it should be appreciated that at least some of the components described below in connection with that the user device 1600 may be optional and thus in an example embodiment may include more, less or different components than those described in connection with the example embodiment of the FIG. 16. As such, among other examples, the user device 1600 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1600 includes a controller or a processor 1602 (e.g., a signal processor, microprocessor, ASIC, or other control and processing logic circuitry) for performing tasks such as signal coding, data processing, image processing, input/output processing, power control, and/or other functions. An operating system 1604 controls the allocation and usage of the components of the user device 1600 and supports for one or more payment application programs (see, applications 1606), that implements one or more of the innovative features as described herein. In addition, the applications 1606 may include common mobile computing applications (e.g., telephony applications, email applications, calendars, contact managers, web browsers, messaging applications) or any other computing application.

The illustrated user device 1600 includes one or more memory components, for example, a non-removable memory 1608 and/or a removable memory 1610. The non-removable memory 1608 and/or the removable memory 1610 may be collectively known as database in an embodiment. The non-removable memory 1608 can include RAM, ROM, flash memory, a hard disk, or other well-known memory storage technologies. The removable memory 1610 can include flash memory, smart cards, or a Subscriber Identity Module (SIM). The one or more memory components can be used for storing data and/or code for running the operating system 1604 and the applications 1606. The user device 1600 may further include a user identity module (UIM) 1612. The UIM 1612 may be a memory device having a processor built in. The UIM 1612 may include, for example, a subscriber identity module (SIM), a universal integrated circuit card (UICC), a universal subscriber identity module (USIM), a removable user identity module (R-UIM), or any other smart card. The UIM 1612 typically stores information elements related to a mobile subscriber. The UIM 1612 in form of the SIM card is well known in Global System for Mobile Communications (GSM) communication systems, Code Division Multiple Access (CDMA) systems, or with third generation (3G) wireless communication protocols such as Universal Mobile Telecommunications System (UMTS), CDMA9000, wideband CDMA (WCDMA) and time division-synchronous CDMA (TD-SCDMA), or with fourth generation (4G) wireless communication protocols such as LTE (Long-Term Evolution).

The user device 1600 can support one or more input devices 1620 and one or more output devices 1630. Examples of the input devices 1620 may include, but are not limited to, a touch screen/a display screen 1622 (e.g., capable of capturing finger tap inputs, finger gesture inputs, multi-finger tap inputs, multi-finger gesture inputs, or keystroke inputs from a virtual keyboard or keypad), a microphone 1624 (e.g., capable of capturing voice input), a camera module 1626 (e.g., capable of capturing still picture images and/or video images) and a physical keyboard 1628. Examples of the output devices 1630 may include but are not limited to a speaker 1632 and a display 1634. Other possible output devices can include piezoelectric or other haptic output devices. Some devices can serve more than one input/output function. For example, the touch screen 1622 and the display 1634 can be combined into a single input/output device.

A wireless modem 1640 can be coupled to one or more antennas (not shown in the FIG. 16) and can support two-way communications between the processor 1602 and external devices, as is well understood in the art. The wireless modem 1640 is shown generically and can include, for example, a cellular modem 1642 for communicating at long range with the mobile communication network, a Wi-Fi compatible modem 1644 for communicating at short range with an external Bluetooth-equipped device or a local wireless data network or router, and/or a Bluetooth-compatible modem 1646. The wireless modem 1640 is typically configured for communication with one or more cellular networks, such as a GSM network for data and voice communications within a single cellular network, between cellular networks, or between the user device 1600 and a public switched telephone network (PSTN).

The user device 1600 can further include one or more input/output ports 1650, a power supply 1652, one or more sensors 1654 for example, an accelerometer, a gyroscope, a compass, or an infrared proximity sensor for detecting the orientation or motion of the user device 1600 and biometric sensors for scanning biometric identity of an authorized user, a transceiver 1656 (for wirelessly transmitting analog or digital signals) and/or a physical connector 1660, which can be a USB port, IEEE 1294 (FireWire) port, and/or RS-232 port. The illustrated components are not required or all-inclusive, as any of the components shown can be deleted and other components can be added.

The disclosed methods with reference to FIG. 10 and FIG. 11, or one or more operations of the method 1000 and the method 1100 may be implemented using software including computer-executable instructions stored on one or more computer-readable media (e.g., non-transitory computer-readable media), such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the servers 130, 135, and 140, its various components such as the computer system 1205 and the database 1210 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and are well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

We claim:

1. A computer implemented method, comprising:
receiving, by a server system associated with a payment network, a declined transaction notification signal about an identification of an authentication credential of a payment card associated with a user as incorrect, the authentication credential provided by the user for initiating a transaction in a transaction capturing device;
verifying, by the server system, if the user has opted for a dual authentication service, wherein the dual authentication service comprises facilitating re-authentication of a declined transaction via an application;
if the user has opted for the dual authentication service, sending, by the server system, a user approval notification signal to a user device via the application, the user approval notification signal sent for seeking a user approval of providing an incorrect authentication credential;
receiving, via the application, by the server system, the user approval of providing the incorrect authentication credential;
electronically facilitating, by the server system, re-authentication of the transaction via the application, wherein re-authentication comprises requesting the user to provide a re-authentication credential via the application; and
electronically facilitating, by the server system, a completion of the declined transaction based at least on verification of the re-authentication credential.

2. The computer implemented method as claimed in claim 1, further comprising:
electronically facilitating an extension of a pre-determined time period to the user to perform the re-authentication.

3. The computer implemented method as claimed in claim 1, wherein the server system is a payment server and wherein the declined transaction notification signal is received from an issuer server, the issuer server configured to perform authentication and authorization.

4. The computer implemented method as claimed in claim 3, further comprising:
receiving the authentication credential from an acquirer server, the acquirer server configured to receive the authentication credential from the transaction capturing device; and
sending the authentication credential for verification to the issuer server, the issuer server configured to generate the declined transaction notification signal upon unsuccessful verification of the authentication credential.

5. The computer implemented method as claimed in claim 1, wherein the transaction is at least one of a non-financial transaction and a financial transaction and wherein the financial transaction comprises an e-commerce transaction.

6. The computer implemented method as claimed in claim 1, further comprising:
receiving, via the application, a user denial of providing the incorrect authentication credential;
electronically reporting the transaction as a fraud transaction; and
aborting the transaction.

7. The computer implemented method as claimed in claim 1, wherein the authentication credential is one of a Personal Identification Number (PIN), a Mobile Personal Identification Number (MPIN), a password, a biometric information, a One-Time Password (OTP), and a user location.

8. The computer implemented method as claimed in claim 7, wherein the re-authentication credential is the authentication credential or one of a particular PIN, a particular MPIN, a password, the biometric information, a particular OTP, and the user location.

9. The computer implemented method as claimed in claim 1, further comprising:
sending the user approval notification signal to the user device via the application to seek user approval of providing a correct authentication credential;
receiving, via the application, the user approval of providing the correct authentication credential;
electronically facilitating re-authentication of the transaction via the application, wherein re-authentication comprises requesting the user to provide the re-authentication credential via the application; and
electronically facilitating the completion of the declined transaction based on verification of the re-authentication credential.

10. A server system in a payment network, comprising:
a communication interface configured to receive a declined transaction notification signal about an identification of an authentication credential of a payment card associated with a user as incorrect, the authentication credential provided by the user for initiating a transaction in a transaction capturing device;
a memory comprising executable instructions; and
a processor communicably coupled to the communication interface and configured to execute the executable instructions to cause the server system to at least:
verify if the user has opted for a dual authentication service, wherein the dual authentication service comprises facilitating re-authentication of a declined transaction via an application;
if the user has opted for the dual authentication service, send a user approval notification signal to a user device via the application, the user approval notification signal sent for seeking a user approval of providing an incorrect authentication credential;
receive, via the application, the user approval of providing the incorrect authentication credential;
electronically facilitate re-authentication of the transaction via the application, wherein re-authentication comprises requesting the user to provide a re-authentication credential via the application; and
electronically facilitate a completion of the declined transaction based on verification of the re-authentication credential.

11. The server system as claimed in claim 10, wherein the server system is further caused to:
electronically facilitate an extension of a pre-determined time period to the user to perform the re-authentication.

12. The server system as claimed in claim 10, wherein the server system is a payment server and wherein the declined transaction notification signal is received from an issuer server, the issuer server configured to perform authentication and authorization.

13. The server system as claimed in claim 12, wherein the server system is further caused to:
receive the authentication credential from an acquirer server, the acquirer server configured to receive the authentication credential from the transaction capturing device; and
send the authentication credential for verification to the issuer server, the issuer server configured to generate the declined transaction notification signal upon unsuccessful verification of the authentication credential.

14. The server system as claimed in claim 10, wherein the transaction is at least one of a non-financial transaction and a financial transaction and wherein the financial transaction comprises an e-commerce transaction.

15. The server system as claimed in claim 10, wherein the server system is further caused to:
receive via the application, a user denial of providing the incorrect authentication credential;
electronically report the transaction as a fraud transaction; and
abort the transaction.

16. The server system as claimed in claim 10, wherein the authentication credential is one of a Personal Identification Number (PIN), a Mobile Personal Identification Number (MPIN), a password, a biometric information, a One-Time Password (OTP), and a user location.

17. The server system as claimed in claim 16, wherein the re-authentication credential is the authentication credential or one of a particular PIN, a particular MPIN, a particular password, the biometric information, a particular OTP, and the user location.

18. The server system as claimed in claim 10, wherein the server system is further caused to:
send the user approval notification signal to the user device via the application to seek the user approval of providing a correct authentication credential;
receive, via the application, the user approval of providing the correct authentication credential;
electronically facilitate re-authentication of the transaction via the application, wherein re-authentication comprises requesting the user to provide the re-authentication credential via the application; and
electronically facilitate the completion of the declined transaction based on verification of the re-authentication credential.

19. A computer implemented method, the computer implemented method comprising:
identifying, by a server system associated with a payment network, an authentication credential of a payment card associated with a user as incorrect, the authentication credential provided by the user for initiating a transaction in a transaction capturing device;
declining, by the server system, the transaction based on identification of an incorrect authentication credential provided by the user;
sending, by the server system, a user approval notification signal to a user device via an application, the user approval notification signal seeking a user approval of providing the incorrect authentication credential;
receiving, via the application, by the server system, the user approval of providing the incorrect authentication credential;
electronically facilitating, by the server system, re-authentication of the transaction via the application, wherein re-authentication comprises requesting the user to provide a re-authentication credential via the application; and
electronically facilitating, by the server system, a completion of a declined transaction based on verification of the re-authentication credential.

20. The computer implemented method as claimed in claim 19, wherein the server system is an issuer server and wherein the computer implemented method further comprises:
sending, by the server system, a declined transaction notification signal to a payment server, the payment server configured to verify if the user has opted for a dual authentication service, wherein the dual authentication service comprises facilitating re-authentication of the declined transaction via the application; and
receiving, by the server system, a successful verification notification signal from the payment server.
